(19) United States
(12) Patent Application Publication
(10) Pub. No.: US 2019/0061288 A1
(43) Pub. Date: Feb. 28, 2019

(54) Application Device And Method For Dispensing A Formed Fibre Composite Strand

(71) Applicant: Airbus Operations GmbH, Hamburg (DE)

(72) Inventors: Jens Wulfsberg, Hamburg (DE); Axel Siegfried Herrmann, Hamburg (DE); Marc Fette, Hamburg (DE); Martin Hentschel, Hamburg (DE)

(73) Assignee: Airbus Operations GmbH, Hamburg (DE)

(21) Appl. No.: 16/113,369

(22) Filed: Aug. 27, 2018

(30) Foreign Application Priority Data
Aug. 30, 2017 (DE) 10 2017 119 936.5

(51) Int. Cl. B29C 70/52; B29C 70/38

(52) U.S. Cl. CPC B29C 70/521; B29C 70/384

(57) ABSTRACT

A mobile application device for dispensing a formed fibre composite strand has: a coupling unit for detachably fastening the application device to the handling device for moving the application device; a preforming unit for continuously forming an unprocessed fibre strand into a formed fibre strand with a formed fibre cross section settable by the preforming unit; an impregnating unit for continuously developing the formed fibre strand into a fibre composite strand by impregnation with a matrix material; and a postforming unit for continuously pressing the fibre composite strand to and through the dispensing unit and having a drive unit and an adjustable dispensing unit for continuously forming a fibre composite strand into a formed fibre composite strand with a dispensing cross section settable by the dispensing unit and for dispensing the same such that the formed fibre cross section is at least 70% congruent with the dispensing cross section.

### FIELD OF THE INVENTION

The invention relates to an application device for dispensing a formed fibre composite strand. The invention furthermore relates to a method for dispensing a formed fibre composite strand.

### BACKGROUND OF THE INVENTION

To produce a fibre composite component, use is often made of short-fibre-reinforced or long-fibre-reinforced thermoplastics. The fibres may for example be carbon fibres, aramid fibres or glass fibres. If short fibres are introduced as a reinforcement into the thermoplastic, they have a mean fibre length of less than 5 mm. In this case, the fibre composite component can be produced from the short-fibre-reinforced thermoplastic by injection moulding or extrusion. By contrast, if long fibres with a mean fibre length of 5 mm to 50 mm are used, then a fibre composite component can be produced therefrom by means of impact extrusion. Particular attention must however be paid to those regions of a fibre composite component to be produced which represent complex geometries with undercuts. This is because such regions may in practice often be subjected to high forces and/or mechanical moments. If such regions are now formed at least substantially only by the thermoplastic matrix material with only a few short fibres or long fibres, this is particularly disadvantageous for the respective stability.

Also known from the prior art are printing methods for printing thermoplastic matrix material containing fibres. The matrix material in this case contains very short fibres, wherein the fibres have a mean fibre length of at most 5 mm. The material used for the printing method is thus a thermoplastic matrix material containing short fibres. In practice, it has however been found that fibre composite components produced with such a material exhibit only limited stability. This applies in particular to sections of the fibre composite component with high geometrical complexity, such as for example a section with an undercut or sections which are elevated above a base surface of a component.

### BRIEF SUMMARY OF THE INVENTION

An aspect of the invention may provide a device and/or a method which permits additive production of a fibre composite component with a complex geometry, in particular with an undercut, by means of a material which imparts particularly high mechanical stability to the fibre composite component to be produced.

An application device for a handling device is thus proposed. The application device serves for dispensing a formed fibre composite strand. The application device has a coupling unit by means of which the application device is detachably fastenable to the handling device, such that the application device is movable in space by the handling device. The application device furthermore has a preforming unit, an impregnating unit and a postforming unit. The postforming unit has a drive unit and an adjustable dispensing unit. The preforming unit is designed to continuously form an unprocessed fibre strand, which is fed continuously to the preforming unit and which has a multiplicity of endless fibres, into a formed fibre strand with a formed fibre cross section settable by the preforming unit. The impregnating unit is designed to continuously develop the formed fibre strand, which is fed continuously from the preforming unit, into a fibre composite strand by impregnation with an incompletely cross-linked matrix material. The drive unit of the postforming unit is designed to continuously press the fibre composite strand, which is fed continuously from the impregnating unit, to and through the dispensing unit. The dispensing unit is designed to continuously form a fibre composite strand, which is pressed continuously through the dispensing unit, into a formed fibre composite strand with a dispensing cross section settable by the dispensing unit, and to dispense same. The preforming unit and the dispensing unit are set such that the formed fibre cross section is at least 70% congruent with the dispensing cross section.

The application device can thus be detachably fastened by means of the coupling unit to the handling device. The application device is thus preferably designed as a mobile application device. If the application device is fastened by means of the coupling unit to the handling device, the handling device can move the application device in space. Thus, by means of the handling device, the application device can for example be moved in guided fashion in space such that the formed fibre composite strand output by the dispensing unit is dispensed along a desired dispensing path. Said dispensing path may preferably be selected such that a complex geometry of a section of a fibre composite component to be produced is created. For example, if it is the intention for the fibre composite component to have a hook-shaped section, then the application device may, for this section of the fibre composite component, be guided by means of the handling device such that a formed fibre composite strand is dispensed by the application device along a dispensing path which is determined by the cross-sectional shape of the hook-shaped section of the fibre composite component. The dispensing path may for example be of arcuate form and/or formed with some other geometry, such that the correspondingly dispensed formed fibre composite strand forms the hook-shaped section of the fibre composite component. Furthermore, the dispensing path may be selected such that it runs along an expected load path of the hook-shaped section of the fibre composite component. By virtue of the fact that that section of the fibre composite component which is realized by a formed fibre composite strand extends along a load path, the same applies to the endless fibres. They thus extend in uninterrupted fashion along the load path. This offers the advantage that possible forces that later act on the hook-shaped section can be transmitted in a particularly effective manner to the rest of the fibre composite component. This is because, by contrast to very short fibres, the forces do not need to be repeatedly transmitted from fibre to fibre along the load path. A section of a fibre composite component produced from the formed fibre composite strand, or a fibre composite component produced entirely from said formed fibre composite strand, can thus be of particularly weight-saving form and at the same time particularly stable. Further advantages of the use of the application device will emerge from the following explanation.

By means of the preforming unit, an unprocessed fibre strand with a multiplicity of endless fibres can be continuously formed into a formed fibre strand. The endless fibres are fibres with a mean fibre length of greater than 80 mm, preferably a mean fibre length of greater than 200 mm. The endless fibres are preferably continuously unrolled from a fibre roll and then conducted as an unprocessed fibre strand to the preforming unit. The unprocessed fibre strand may also be configured as a roving and/or referred to as a roving. By means of an adaptation of the quantity of the multiplicity of endless fibres and/or by means of the geometrical distribution with respect to a passage cross section of the preforming unit, the preforming unit can be configured to form the formed fibre cross section. By means of corresponding adaptation possibilities of the preforming unit, the formed fibre cross section can be set. In other words, the preforming unit can dispense a formed fibre strand with a settable or set formed fibre cross section. This offers the advantage that the endless fibres in the formed fibre strand are already arranged so as to be distributed over the cross section of the formed fibre strand such that the endless fibres form, in the cross section, the formed fibre cross section. The formed fibre cross section may in this case have for example at least approximately the form as is later provided for the formed fibre composite strand during the dispensing by the application device. By means of the preforming unit, it can thus preferably be ensured that the formed fibre composite strand has a particularly advantageous distribution with regard to the fibres contained therein.

A formed fibre strand provided by the preforming unit can be guided and/or conveyed continuously to the impregnating unit. The application device may be designed correspondingly for this purpose.

The impregnating unit serves for impregnating the formed fibre strand with incompletely cross-linked matrix material. This impregnation is performed continuously. The fibre composite strand can thus be dispensed continuously from the impregnating unit. The fibre composite strand is thus created by the impregnating unit by impregnation of the fibre composite strand with the incompletely cross-linked matrix material. The matrix material is for example thermosetting matrix material or thermoplastic matrix material. For the impregnation, it is furthermore advantageous if the matrix material is liquid or viscous. Since the formed fibre strand is fed continuously and the fibre composite strand is created and/or provided continuously by the impregnating unit, provision is made for the impregnating unit to also be designed for continuous impregnation.

The fibre composite strand has a fibre composite cross section. The fibre composite cross section preferably corresponds at least substantially to the formed fibre cross section. It has proven to be advantageous if the fibre composite cross section is at least 70% congruent with the formed fibre cross section. Owing to the great cross-sectional similarity between the formed fibre strand and the fibre composite strand, the advantages offered by the formed fibre strand with regard to the distribution of the fibres can be maintained.

The fibre composite strand may be guided and/or conveyed continuously to the postforming unit, and in particular to the associated drive unit. The application device may be designed correspondingly to this purpose.

By means of the drive unit, the fibre composite strand can be pressed continuously to and through the dispensing unit. The drive unit and the dispensing unit may, for this purpose, be arranged directly in series. By means of the dispensing unit, a fibre composite strand pressed continuously through the dispensing unit is formed into a or the formed fibre composite strand, and dispensed. For this purpose, from the dispensing unit, there may be provided a guide channel through which the fibre composite strand is pressed and, in the process, based on a passage cross section of the guide channel, is formed into the formed fibre composite strand with the associated dispensing cross section. The preforming unit and the dispensing unit are set such that the formed fibre cross section is at least 70% congruent with the dispensing cross section. This ensures that the dispensing unit does not have to completely deform the fibre composite strand, but rather only a slight cross-sectional adaptation is sufficient to ensure the dispensing cross section for the formed fibre composite strand. The dispensing unit and the preforming unit are each settable, such that the desired congruity can be realized. In practice, provision may be made for the dispensing cross section to be predetermined. In this case, the preforming unit may be set such that the formed fibre cross section is at least 70% congruent with the desired dispensing cross section.

With regard to the example discussed above with the fibre composite component to be produced which has a hook-shaped section, provision may for example be made for the hook-shaped section to have a particular thickness and/or a particular width. With these specifications, an advantageous dispensing cross section for the dispensing unit can be selected. This can be ensured through setting of the dispensing unit. Corresponding settings are also possible on the preforming unit in order to achieve the desired congruity. If the formed fibre composite strand is now dispensed by means of the application device along the above-discussed dispensing path, this offers the advantage that the fibres of the dispensed formed fibre composite strand are arranged at least substantially along the dispensing path or parallel thereto. Since the fibres are endless fibres, these can transmit forces that act on the hook-shaped section of the fibre composite component in a particularly effective manner to further sections of the fibre composite component. This is the case in particular if the dispensing path is selected to run at least substantially along a predictable path within the hook-shaped section of the fibre composite component along which a particularly advantageous transmission of forces is possible.

Since the fibre composite strand can be guided along a predetermined path by means of the dispensing unit and at least indirectly by the handling device, the application device can also be referred to as an applicator or as a printing device. The dispensing unit itself can also be referred to as a nozzle unit.

To detachably fasten the coupling unit to the handling device, the coupling unit may for example be designed as a fastening plate or as a fastening frame. A receiving unit formed correspondingly to the coupling unit may be provided for the handling device. Thus, a detachable fastening and/or detachable mechanical connection is possible between the coupling unit and the receiving unit of the handling device. The handling device may for example be designed as a robot, in particular an industrial robot, or as a portal robot, for example a portal robot that can be moved by means of linear drives.

With regard to the formed fibre cross section and the dispensing cross section, it is pointed out that the expression “congruent” preferably relates to a comparison of the two cross sections. The two cross sections practically do not need to be laid directly one on top of the other for this purpose. Rather, the comparison may be regarded as a theoretical technical comparison. Actual “laying one on top of the other” is not necessary. In one example, the congruity is determined from that part of the dispensing cross section which, in the case of formed fibre cross section and dispensing cross section being theoretically laid one on top of the other, overlaps the formed fibre cross section, in relation to the entire dispensing cross section or in relation to the entire formed fibre cross section. An inverse determination is likewise conceivable. In a further example, the congruity is thus determined from that part of the formed fibre cross section which, in the case of formed fibre cross section and dispensing cross section being theoretically laid one on top of the other, overlaps the dispensing cross section, in relation to the entire dispensing cross section or in relation to the entire formed fibre cross section. Complete congruity exists for example if the outer contour of the formed fibre cross section corresponds to the outer contour of the dispensing cross section. If this is not the case, the formed fibre cross section and the dispensing cross section may for example partially correspond to one another. In this case, it is for example the case that congruity of less than 100% exists. For the application device, provision is made for the preforming unit and the dispensing unit to be set such that the formed fibre cross section is at least 70% congruent, or more, with the dispensing cross section. Thus, the preforming unit and the dispensing unit may for example be set such that the formed fibre cross section is at least 75%, at least 80%, at least 85% or at least 90% congruent with the dispensing cross section.

The high congruity of the two cross sections offers the advantage that an advantageous distribution and/or density of fibres in the fibre composite component to be produced, or in the formed fibre composite strand, can be achieved. The high congruity of the cross sections furthermore offers the advantage that the endless fibres can be laid along load paths of the fibre composite component to be produced.

The matrix material that can be used for the impregnation by means of the impregnating unit is preferably incompletely cross-linked matrix material. This matrix material may for example be incompletely cross-linked thermoset or thermosetting matrix material. Provision may however also particularly preferably be made for said matrix material to be incompletely cross-linked thermoplastic or thermoplastic material.

For the postforming unit and/or for the application device as a whole, a temperature-control unit may be provided which is designed for the curing or for the solidification of the dispensed formed fibre composite strand. For this purpose, the temperature-control unit may be designed to perform the curing by means of heat, cold and/or light.

It has furthermore proven to be advantageous if the coupling unit, the preforming unit, the impregnating unit and the dispensing unit of the application device are mechanically connected and/or coupled to one another. This may be realized for example also by means of a frame of the application device. Thus, the coupling unit, the preforming unit, the impregnating unit and/or the postforming unit may be mechanically connected to the frame of the application device. This offers the advantage that the application device is freely movable in space by means of the handling device.

It has proven to be advantageous if the endless fibres are configured as carbon fibres, aramid fibres and/or glass fibres. It may furthermore be advantageous if the endless fibres are configured as hybrid fibres. In this case, the endless fibres may be formed from at least two different fibre types, such as for example carbon fibres and glass fibres.

For the impregnation, it has proven to be advantageous if this is performed by injection of the incompletely cross-linked matrix material. Thus, the incompletely cross-linked matrix material can be injected by means of the impregnating unit onto or into the formed fibre strand in order to form the fibre composite strand. It has however also proven to be advantageous if the impregnation is performed by means of the impregnating unit by means of a matrix bath. Thus, the impregnating unit may have a vessel, in particular a bath, in which the incompletely cross-linked matrix material is introduced. Furthermore, the impregnating unit may be designed to guide the continuously fed formed fibre strand through the incompletely cross-linked matrix material in the vessel in order to then form the fibre composite strand therefrom.

One advantageous embodiment of the application device is characterized in that the preforming unit has a first tool receptacle and a first forming tool which is held in an exchangeable manner by the first tool receptacle, wherein the formed fibre cross section is determined by the first forming tool. The first tool receptacle may be designed to detachably hold and/or fasten the first forming tool, such that the first forming tool is exchangeable. The first forming tool can thus be exchanged for another first forming tool, such that a correspondingly different, desired formed fibre cross section can be achieved. The first forming tool is preferably designed as a modular forming tool. The first forming tool can thus also be referred to as a first forming tool module. The first forming tool may form a guide channel for the unprocessed fibre strand, such that the formed fibre strand is formed therefrom. By virtue of the fact that the first forming tool can be held exchangeably by the first tool receptacle, the preforming unit is settable. This is because, through the selection of the first forming tool that is held by the first tool receptacle, the formed fibre cross section can be determined and thus set. The preforming unit is thus settable in order to achieve a desired formed fibre cross section.

A further advantageous embodiment of the application device is characterized in that the dispensing unit has a second tool receptacle and a second forming tool which is held in an exchangeable manner by the second tool receptacle, wherein the dispensing cross section is determined by the second forming tool. The second tool receptacle may be designed to detachably hold and/or fasten the second forming tool, such that the second forming tool is exchangeable. The second forming tool can thus be exchanged for another second forming tool, such that a correspondingly different, desired dispensing cross section can be achieved. The second forming tool is preferably designed as a modular forming tool. The second forming tool can thus also be referred to as a second forming tool module. The second forming tool may form a guide channel for the fibre composite strand, such that the formed fibre composite strand is formed therefrom. By virtue of the fact that the second forming tool can be held exchangeably by the second tool receptacle, the dispensing unit is settable. This is because, through the selection of the second forming tool that is held by the second tool receptacle, the dispensing cross section can be determined and thus set. The dispensing unit is thus settable in order to achieve a desired dispensing cross section.

A further advantageous embodiment of the application device is characterized in that the first forming tool and the second forming tool are determined and/or designed relative to one another such that the formed fibre cross section is at least 70% congruent with the dispensing cross section. Thus, the passage cross section of the guide channel of the preforming unit may for example be determined and/or designed such that said passage cross section is, in relation to the passage cross section of a guide channel of the dispensing unit, configured such that the passage cross sections of the two guide channels are at least 70% congruent. This has the result that the formed fibre cross section is likewise at least 70% congruent with the dispensing cross section. Through the suitable selection of the first forming tool and of the second forming tool, it is thus possible to achieve the desired congruity. The advantages of a high degree of congruity have been discussed above. At this juncture, reference is made analogously to corresponding explanations.

In practice, provision may be made for the first forming tool to be selected such that the formed fibre cross section is at least 70% congruent with the dispensing cross section. Thus, if a particular dispensing cross section for the dispensing of the formed fibre composite strand is desired, for example in order to realize as advantageous as possible an embodiment of a projection of a fibre composite component to be produced, then it is possible through the selection of the second forming tool to firstly set the dispensing cross section, and through suitable selection of a first forming tool to set a fibre formed cross section, such that the desired congruity is ensured.

To keep the mechanical complexity of the first forming tool as low as possible, it has proven to be advantageous if the first forming tool is designed to exactly determine a formed fibre cross section. The first forming tool may for example be of unipartite design. This may correspondingly apply to the second forming tool. To thus keep the mechanical complexity of the second forming tool as low as possible, it has proven to be advantageous for the second forming tool to be designed to exactly determine a formed fibre cross section. The second forming tool may for example be of unipartite design.

An advantageous embodiment of the application device is characterized in that the preforming unit has multiple adjustable preforming tool parts for forming the formed fibre strand, wherein the preforming unit is controllable for the adjustment of the preforming tool parts in order to form the formed fibre strand with a formed fibre cross section set in a controlled manner. To thus set a desired formed fibre cross section, the preforming tool parts are controlled so as to be adjusted such that, by means of the preforming tool parts, the formed fibre strand can be formed with the desired formed fibre cross section now set. Preferably, the preforming tool parts are controllable in order to set a passage cross section of the preforming unit. Owing to the adjustable preforming tool parts, it is not necessary for the preforming unit to have an exchangeable forming tool. Rather, the desired formed fibre cross section can be realized through the adjustment of the preforming tool parts. The adjustability of the preforming tools furthermore offers the advantage that the desired formed fibre cross section can be set particularly easily and quickly. Provision may furthermore be made for the preforming unit to be designed to adjust the preforming tools in controlled fashion during the operation of the application device.

A further advantageous embodiment of the application device is characterized in that the dispensing unit has multiple adjustable dispensing forming tool parts for forming the formed fibre composite strand, wherein the dispensing unit is controllable for the adjustment of the dispensing forming tool parts in order to form the formed fibre composite strand with a dispensing cross section set in a controlled manner. To thus set a desired dispensing cross section, the postforming tool parts are controlled so as to be adjusted such that, by means of the postforming tool parts, the formed fibre composite strand can be formed with the desired dispensing cross section now set. Preferably, the postforming tool parts are controllable in order to set a passage cross section of the dispensing unit. Owing to the adjustable postforming tool parts, it is not necessary for the dispensing unit to have an exchangeable forming tool. Rather, the desired dispensing cross section can be realized through the adjustment of the postforming tool parts. The adjustability of the postforming tools furthermore offers the advantage that the desired dispensing cross section can be set particularly easily and quickly. Provision may furthermore be made for the dispensing unit to be designed to adjust the postforming tools in controlled fashion during the operation of the application device.

A further advantageous embodiment of the application device is characterized in that the application device has an applicator control unit which is designed to control the preforming unit and/or the dispensing unit such that the formed fibre cross section is at least 70% congruent with the dispensing cross section. By means of the applicator control unit, it is for example possible for the preforming tool parts of the preforming unit to be controlled such that the formed fibre strand has a formed fibre cross section which is at least 70% congruent with the dispensing cross section. Alternatively or in addition, the applicator control unit may be designed to control an adjustment of the dispensing forming tools such that the formed fibre cross section is at least 70% congruent with the dispensing cross section.

Provision is preferably made for the applicator control unit to control the preforming unit in a manner dependent on a setting of the dispensing unit. Thus, for example, if a dispensing cross section is predefined, the applicator control unit may firstly be designed to adjust the dispensing tool parts in controlled fashion such that the formed fibre composite strand has the desired dispensing cross section. Furthermore, the applicator control unit may be designed to, in particular subsequently, control the preforming unit in order to adjust the preforming tools such that the formed fibre strand is formed with a formed fibre cross section which is at least 70% congruent with the dispensing cross section.

A further advantageous embodiment of the application device is characterized in that the application device has a curing unit for curing the formed fibre composite strand. The curing unit is preferably assigned to the postforming unit of the application device. The curing unit may thus constitute for example a part, in particular an integral part, of the postforming unit. It has furthermore proven to be advantageous if the curing unit is designed as a heating unit for warming the formed fibre composite strand. This is the case in particular if thermosetting matrix material has been used for the impregnation. This is because the thermosetting matrix material can be cured by means of a supply of heat. Alternatively or in addition, the curing unit may have an exposure unit which is designed to emit light onto the formed fibre composite strand such that the formed fibre composite strand cures. The light may be light from the ultraviolet spectrum. The spectrum of the light beam is preferably configured such that it is suitable and/or predetermined for curing a thermosetting matrix material.

A further advantageous embodiment of the application device is characterized in that the application device has a solidification unit for solidifying the formed fibre composite strand. The solidification unit is preferably assigned to the postforming unit of the application device. The solidification unit may thus constitute for example a part, in particular an integral part, of the postforming unit. It has furthermore proven to be advantageous if the curing unit is designed as a cooling unit for cooling the formed fibre composite strand. This is the case in particular if thermoplastic matrix material has been used for the impregnation. This is because the thermoplastic matrix material can be solidified by cooling. The cooling may be realized for example by air. Thus, the cooling unit may for example have an air blower, such that the formed fibre composite strand can be cooled by means of the cooling unit. The cooling may however also be realized by means of a heat exchanger. Thus, the cooling unit may have a heat exchanger for cooling the formed fibre composite strand. As coolant, use may for example be made of water, oil or some other liquid coolant.

With regard to the system according to the second aspect of the invention, reference is furthermore made analogously to the above explanations, preferred embodiments, preferred features, advantages and/or effects as have been discussed for the application device according to the first aspect of the invention or the associated embodiments.

Thus, a system for dispensing a formed fibre composite strand is provided. The system has an application device such as has been discussed above in accordance with the first aspect of the invention, and preferably in accordance with one of the advantageous embodiments. Furthermore, the system has a handling device which is designed to move an associated receiving unit in space in a controlled manner. Furthermore, the system has a system control unit for controlling the handling device. The coupling unit of the application device is fastened to the receiving unit of the handling device such that the application device is connected to the handling device and is fully supported by the handling device. Preferably, the system control unit is configured to control the handling device such that the receiving unit of the handling device is moved along a predetermined trajectory. Thus, the system control unit may for example be configured such that the receiving unit is moved along a predetermined trajectory such that the corresponding path of the application device is determined such that, by means of the application device, a formed fibre composite strand is guided along the trajectory for a fibre composite component to be produced. Here, the trajectory may correspond to a load path of the fibre composite component to be produced.

The handling device is preferably designed as a robot, in particular an industrial robot. Provision may also be made for the handling device to be designed as a portal robot, in particular a portal robot movable by means of linear drives. The handling device may also be constituted by, or have, a manipulator. The handling device may thus also be referred to as a manipulator. It has furthermore proven to be advantageous for the handling device to have a linear kinematic arrangement; this applies in particular in the context of the portal robot. The system control unit may be configured to control the robot or the portal robot such that the receiving unit of the robot or of the portal robot is moved in order to guide the dispensing unit of the application device along the trajectory. In the case of the robot, the receiving unit may for example be arranged on the end of an arm. The advantages and/or effects as have been discussed in conjunction with the application device are otherwise realized analogously. Reference is therefore made to these analogously for the system.

An advantageous embodiment of the system is characterized in that the applicator control unit is assigned to the system control unit. The system control unit may have multiple sub-units, wherein one of said sub-units is constituted by the applicator control unit. Thus, the system control unit may for example also be designed to control the preforming unit and/or the dispensing unit such that the formed fibre cross section is at least 70% congruent with the dispensing cross section.

A further advantageous embodiment of the system is characterized in that the applicator control unit is controlled by the system control unit. For this purpose, the applicator control unit and the system control unit may be connected by means of a signal control connection, in particular a wired signal control connection. The system control unit may for example be configured to transmit control signals to the applicator control unit such that the latter controls the preforming unit and/or the dispensing unit such that the formed fibre cross section is at least 70% congruent with the dispensing cross section.

A further advantageous embodiment of the system is characterized in that the applicator control unit is constituted by the system control unit. In this case, provision may be made for the applicator control unit to not be arranged directly on the application device. Provision may furthermore be made for the applicator control unit to form an integral part of the system control unit.

It is furthermore pointed out that the advantages, effects and/or advantageous embodiments that have already been discussed in conjunction with the applicator control unit may apply analogously to the system control unit. Reference is preferably made analogously to corresponding explanations.

One advantageous embodiment of the system is characterized in that the system control unit is configured to control the drive unit and/or the dispensing unit by means of the applicator control unit. This is advantageous in particular if the system control unit also serves for controlling the handling device. Thus, the drive unit and/or the dispensing unit, by means of the application unit, can be controlled by means of the system control unit in a manner dependent on a movement of the handling device by means of the system control unit.

A further advantageous embodiment of the system is characterized in that the system has a curing unit and/or a solidification unit which is designed for curing and/or solidifying the formed fibre composite strand. Reference is made analogously to corresponding advantageous explanations, preferred features, advantages and/or effects such as have been discussed with regard to the curing unit and/or the solidification unit of the application device, wherein provision is however now made for the curing unit and/or the solidification unit to be assigned to the system. The curing unit and/or the solidification unit may thus be designed to be decoupled from the application device.

A method is thus proposed for dispensing a formed fibre composite strand by means of an application device which, by means of an associated coupling unit, is detachably fastenable to a handling device, such that the application device is movable in space by the handling device. In a step a) of the method, provision is made for continuous formation of an unprocessed fibre strand, which is fed continuously to a preforming unit of the application device and which has a multiplicity of endless fibres, into a formed fibre strand with a formed fibre cross section settable by the preforming unit. A step b) of the method is characterized by continuous impregnation of the formed fibre strand with an incompletely cross-linked matrix material, by means of an impregnating unit of the application device, to realize a fibre composite strand, wherein the formed fibre strand is fed continuously to the impregnating unit. A step c) of the method is characterized by continuous pressing of the fibre composite strand, which is fed continuously to a drive unit of the application device from the impregnating unit, to and through a dispensing unit of the application device by means of the drive unit. In a step d) of the method, provision is made for continuous forming of the fibre composite strand, which is pressed continuously through the dispensing unit, into a formed fibre composite strand by means of the dispensing unit with a dispensing cross section settable by the dispensing unit, and dispensing of same, wherein the preforming unit and the dispensing unit are set such that the formed fibre cross section is at least 70% congruent with the dispensing cross section.

With regard to the method, reference is made analogously to the above explanations, preferred embodiments, advantageous features, advantages and/or effects such as have been described for the application device according to the first aspect of the invention and the system according to the second aspect of the invention and the corresponding advantageous embodiments.

It is furthermore pointed out once again that the above-described steps of the method are performed by means of the application device, which is detachably fastened to the handling device and is movable in space by said handling device. The continuous forming of the formed fibre strand with the formed fibre cross section, the subsequent impregnation and the continuous forming and dispensing of the formed fibre composite strand with the dispensing cross section are thus performed by means of the application device. The latter may for example be designed as a mobile application device. This is advantageous in particular if the handling device is designed as a robot, and the application device is arranged detachably on one end of the arm of the robot. The setting of the formed fibre and dispensing cross sections is thus performed in decentralized fashion by means of the application device. Furthermore, the impregnation is performed by means of the application device. Finally, the two abovementioned cross sections are advantageously set with respect to one another such that an advantageous distribution and/or density of the fibres in the formed fibre composite strand can be ensured.

One advantageous embodiment of the method is characterized in that the preforming unit has multiple adjustable preforming tool parts for forming the formed fibre strand, the preforming unit is controllable for the adjustment of the preforming tool in order to form the formed fibre strand with a formed fibre cross section set in a controlled manner, the dispensing unit has multiple adjustable dispensing forming tool parts for forming the formed fibre composite strand, the dispensing unit is controllable for the adjustment of the dispensing forming tool in order to form the formed fibre composite strand with a dispensing cross section set in a controlled manner, and the preforming unit and/or the dispensing unit are/is controlled such that the formed fibre cross section is at least 70% congruent with the dispensing cross section. With regard to the adjustment of the preforming tool parts and the dispensing tool parts and with regard to the correspondingly settable cross sections, reference is made analogously to the associated preceding explanations, preferred embodiments, advantageous features, advantages and/or effects, such as have been advantageously discussed in this regard in the context of the application device.

A further advantageous embodiment of the method is characterized in that the application device is fastened by means of the coupling unit to a receiving unit such that the application device is connected to the handling device and is fully supported by the handling device, and wherein the application device is, by means of the handling device, guided through space such that the dispensing unit is guided along a, in particular predetermined, dispensing path while the application device continuously dispenses the formed fibre composite strand, such that the fibres in the formed fibre composite strand extend at least substantially without bends and/or without loops along the dispensing path. The dispensing path preferably represents a path along a cross-sectional contour of a section of a fibre composite component to be produced. Said section may for example relate to a geometrically complex section of the fibre composite component to be produced. If the fibre composite component is now thus dispensed in continuous fashion such that the fibres in the fibre composite strand extend at least substantially without bends and/or without loops along the dispensing path, it can be ensured that reaction forces are likewise distributed correspondingly to the dispensing path. If the dispensing path furthermore corresponds to the path along a cross-sectional contour of a section of the fibre composite component to be produced, then the corresponding forces can be distributed particularly advantageously within the fibre composite component. This increases the stability of the fibre composite component to be produced.

### BRIEF DESCRIPTION OF THE DRAWINGS

Further features, advantages and/or possible uses of the present invention will emerge from the following description of the exemplary embodiments and/or from the figures. Here, all of the features described and/or illustrated in the figures, individually and/or in any desired combination, constitute a subject of the invention, even independently of their combination in the individual claims and/or the back-references thereof. Furthermore, in the figures, the same reference designations are used for identical or similar objects.

FIG. 1 shows the schematic construction of a first advantageous embodiment of the application device 2.

FIG. 2 shows an advantageous embodiment of the handling device 4, with an application device 2 detachably fastened thereto, in a schematic view.

FIGS. 3a, 3b, 5a, 5b each show advantageous embodiments of a passage cross section of an advantageous embodiment of the preforming unit.

FIGS. 4a, 4b, 6a, 6b each show an advantageous embodiment of a passage cross section of an advantageous embodiment of the dispensing unit.

FIG. 7 shows a second advantageous embodiment of the application device in a schematic view.

FIG. 8 shows a third advantageous embodiment of the application device in a schematic view.

FIG. 9 shows a fourth advantageous embodiment of the application device in a schematic view.

FIG. 10 shows an advantageous embodiment of a schematic flow diagram of the method.

### DETAILED DESCRIPTION

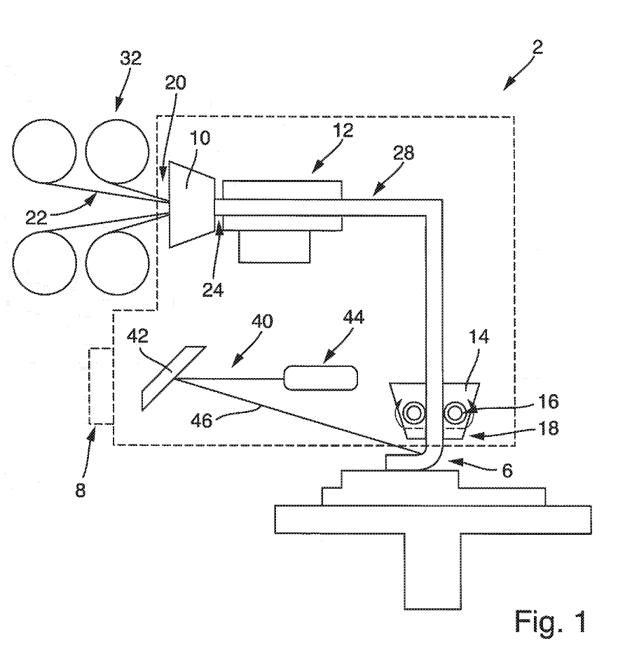

FIG. 1 illustrates a first advantageous embodiment of the application device 2 in a schematic view. The application device 2 has a coupling unit 8, a preforming unit 10, an impregnating unit 12 and a postforming unit 14. The abovementioned units are directly or indirectly mechanically coupled or connected to one another, such that the application device 2 is preferably designed as a mobile application device 2. A region of the application device 2 is advantageously bordered by the dashed line.

The preforming unit 10, the impregnating unit 12 and the postforming unit 14 are advantageously arranged directly in series, and are in each case mechanically connected to one another in series. It is furthermore possible for the abovementioned units to be connected by means of a common frame (not illustrated).

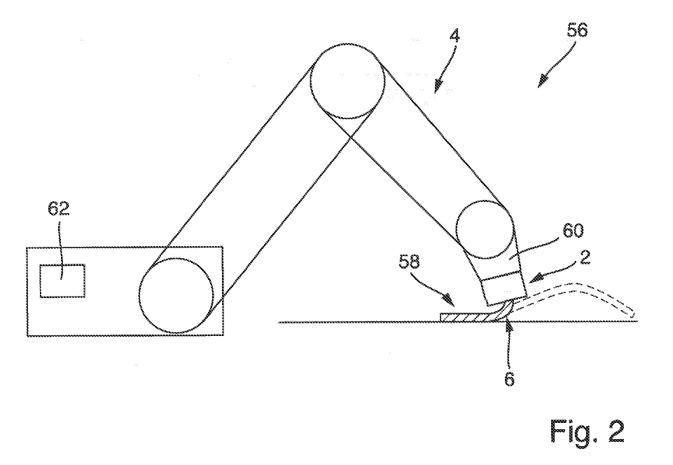

The application device 2 has a coupling unit 8. It may likewise be connected to the other units and/or to the frame. By means of the coupling unit 8, the application device 2 is detachably fastened or fastenable to a handling device 4, as is schematically illustrated for example in FIG. 2. If the application device 2 is fastened by means of the coupling unit 8 to the handling device 4, the application device 2 can be moved into space by the handling device 4. In particular, said application device can be moved freely in space.

The application device 2 serves for dispensing a formed fibre composite strand 6. The formed fibre composite strand 6 has a matrix material into which fibres are introduced. A formed fibre composite strand 6 of said type serves for constituting at least a part of a fibre composite component 58. Fibre composite components 58 are in practice not uncommonly subjected to high forces and/or subject to high demands with regard to the geometrical shape thereof and/or with regard to as low a weight as possible. Thus, if a formed fibre composite strand 6 is now used for producing a fibre composite component 58 with a geometrically complex form, wherein it is the intention for the fibre composite component 58 to be produced to be subjected to particularly high forces, it is of great interest for the fibres in the fibre composite strand 6 to be arranged in a predictable distribution and/or quantity.

To ensure the above-stated requirements in a particularly advantageous manner, the application device 2 has the preforming unit 10, the impregnating unit 12 and the postforming unit 14, wherein the postforming unit 14 in turn has a drive unit 16 and a settable dispensing unit 18.

Here, the preforming unit 10 is designed to continuously form an unprocessed fibre strand 20, which is fed continuously to the preforming unit 10 and which has a multiplicity of endless fibres 22, into a formed fibre strand 24 with a formed fibre cross section 26 settable by the preforming unit 10. The preforming unit 10 is therefore preferably designed as a settable preforming unit 10. The endless fibres 22 may be unrolled from fibre rolls 32. Said fibre rolls 32 may be held by the application device 2. It is however also possible for the fibre rolls 32 to not be assigned to the application device 2. In this case, the fibre rolls 32 may for example be arranged in a stationary manner or on the handling device 4. In this case, the endless fibres 22 may be guided from the handling device 4 to the application device 2 or to the associated preforming unit 10.

The endless fibres 22 are preferably carbon fibres, glass fibres or aramid fibres. For the endless fibres 22, hybrid fibres are however also conceivable, which have multiple different fibre types, such as for example carbon fibres and glass fibres. Endless fibres 22 are furthermore characterized by a mean fibre length of greater than 80 mm, greater than 120 mm or greater than 200 mm. During the operation of the application device 2, the unprocessed fibre strand 20 is fed in uninterrupted or continuous fashion to the preforming unit 10 from the multiplicity of endless fibres 22. Here, provision may be made for the unprocessed fibre strand 20 to be pulled through the preforming unit 10.

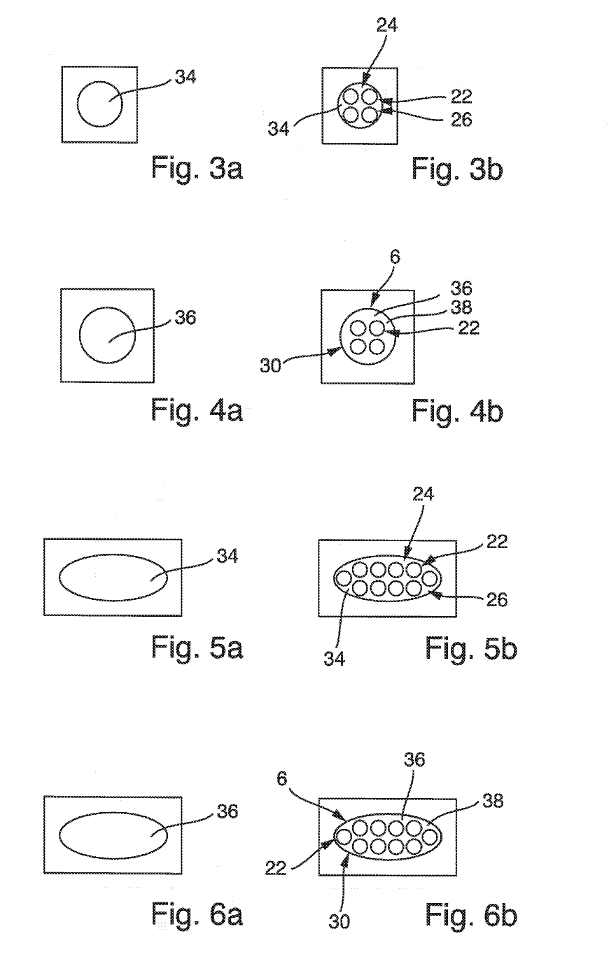

The preforming unit 10 is furthermore designed to form the formed fibre strand 24 from the unprocessed fibre strand 20, such that the formed fibre strand 24 has a formed fibre cross section 26. For this purpose, the preforming unit 10 may have a passage cross section 34 as is schematically illustrated in FIG. 3a or 5a. If the unprocessed fibre strand 20 with the multiplicity of endless fibres 22 is now guided through the preforming unit 10, the preforming unit 10 forms the unprocessed fibre strand, for example by radial compression and/or diverting of the endless fibres 22, such that the formed fibre strand 24 that is created, as schematically illustrated for example in FIG. 3b or 5b, has a formed fibre cross section 26. The formed fibre strand 24 thus likewise has the multiplicity of endless fibres 22, but these are now compressed, and/or arranged in a changed manner relative to one another in the radial direction, such that the desired formed fibre cross section 26 is realized.

Furthermore, the preforming unit 10 is designed to be settable, such that the preforming unit 10 is designed to form the formed fibre strand 24 with a formed fibre cross section 26 settable by the preforming unit 10. For this purpose, a first exchangeable forming tool may be used for the preforming unit 10. Through the selection of the first forming tool, the desired formed fibre cross section 26 can be set. This is because, through the selection of the first forming tool, it is for example possible for the passage cross section 34 to be set. FIG. 5a illustrates, for example, a different passage cross section 34 for the preforming unit 10 than FIG. 3a. These different passage cross sections 34 can thus be provided by different first forming tools for the preforming unit 10. If, for example, it is sought to use a first forming tool with the passage cross section 34 illustrated in FIG. 5a, then, during the operation of the application device 2, it is advantageous if a relatively large multiplicity of endless fibres 22 is used, such that the formed fibre strand 24 with the desired formed fibre cross section 26 can be formed from the corresponding unprocessed fibre strand 20, as is schematically illustrated in FIG. 5b.

Instead of using a first forming tool for the preforming unit 10 for setting the formed fibre cross section 26, provision may be made for the preforming unit 10 to have multiple adjustable preforming tool parts for forming the formed fibre strand 24. The preforming tool parts may preferably be adjustable such that, depending on the setting, a different passage cross section 34 can be realized. Thus, the preforming tool parts may for example be adjusted such that they form a passage cross section 34 as shown in FIG. 3a or in FIG. 5a. Furthermore, the preforming unit 10 is preferably controllable for the adjustment of the preforming tool parts in order to form the formed fibre strand 24 with the formed fibre cross section 26 now set in a controlled manner.

During the operation of the application device 2, the formed fibre strand 24 is fed continuously from the preforming unit 10 to the impregnating unit 12. The impregnating unit 12 is designed to impregnate the continuously fed formed fibre strand 24 with an incompletely cross-linked matrix material, such that a fibre composite strand 28 is continuously created. In the design variant of the application device 2 illustrated in FIG. 1, provision is made for the formed fibre strand 24 to be continuously formed into the fibre composite strand 28 by means of injection impregnation with the incompletely cross-linked matrix material. Here, the incompletely cross-linked matrix material may be sprayed or injected onto the formed fibre strand 24. This offers the advantage that the fibre composite strand 28 that is created at least substantially has a similar fibre composite cross section to the formed fibre strand 24.

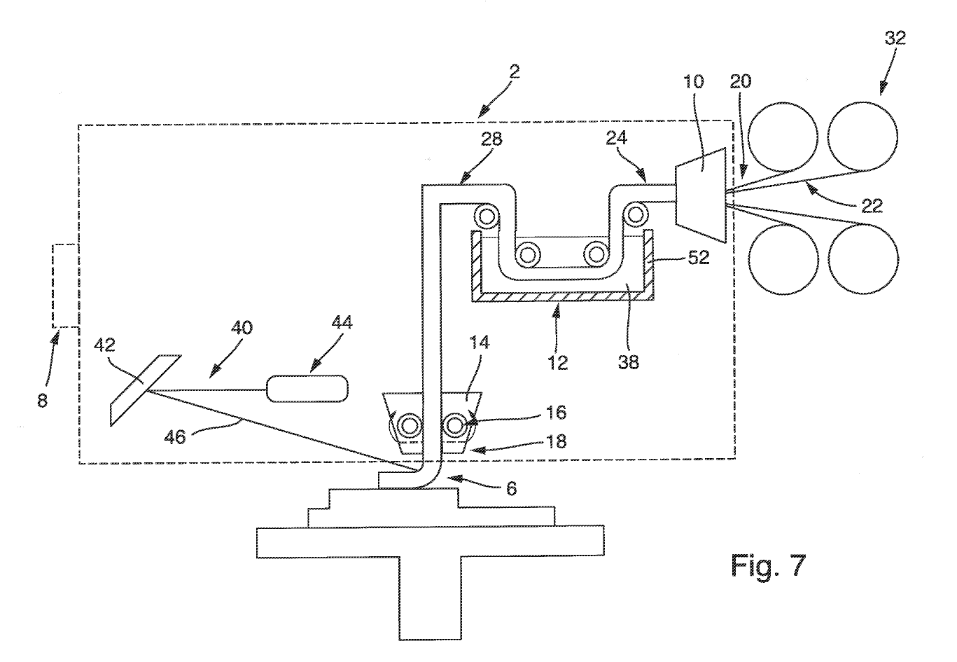

Instead of the impregnating unit 12 as is schematically illustrated in FIG. 1, the impregnating unit 12 may also be designed differently. FIG. 7 schematically illustrates, for example, the at least substantially identical application device 2, wherein the impregnating unit 12 is however designed to guide the formed fibre strand 24 continuously through a trough-like vessel with the incompletely cross-linked matrix material, in order to realize the impregnation and thus create the fibre composite strand 28.

Both for the injection impregnating unit 12 as is schematically illustrated in FIG. 1 and for the design variant of the impregnating unit 12 as is schematically illustrated in FIG. 7, use is made of a flowable incompletely cross-linked matrix material. This is for example an incompletely cross-linked thermosetting matrix material.

The application device 2, such as is illustrated by way of example in FIG. 1, furthermore has the postforming unit 14. The postforming unit 14 comprises a drive unit 16 and a settable dispensing unit 18. The drive unit 16 is designed to continuously press the fibre composite strand 28, which is fed continuously from the impregnating unit 12, to and through the dispensing unit 18. Furthermore, the drive unit 16 is preferably designed to pull the fibre composite strand 28 from the impregnating unit 12 to the drive unit 16. Corresponding tensile forces therefore also act, oppositely to the process direction, on the unprocessed fibre strand 20 and on the endless fibres 22. In other words, the drive unit 16 may be designed to convey the different sub-sections or strands 20, 24, 28.

The dispensing unit 18 is designed to continuously form the fibre composite strand 28, which is pressed continuously through the dispensing unit 18, into the formed fibre composite strand 6, and to dispense same. The dispensing unit 18 in this case preferably has a passage cross section 36. This is schematically illustrated in FIG. 4a or 6a. In one exemplary embodiment, the passage cross section 36 of the dispensing unit 18 at least substantially corresponds to the passage cross section 34 of the preforming unit 10.

Furthermore, the dispensing unit 18 is of settable design, such that the dispensing unit 18 is designed to form the formed fibre composite strand 6 with a dispensing cross section 30 settable by the dispensing unit 18. For this purpose, a first, exchangeable forming tool may be used for the dispensing unit 18. Through the selection of the first forming tool, the desired dispensing cross section 30 can be set. Instead of using a first forming tool for the dispensing unit 18 for setting the dispensing cross section 30, provision may be made for the dispensing unit 18 to have multiple adjustable dispensing forming tool parts for forming the formed fibre composite strand 6. The dispensing forming tool parts may preferably be adjustable such that a different passage cross section 36 can be realized depending on the setting.

If the fibre composite strand 28 is now pressed continuously through the dispensing unit 28, the formed fibre composite strand 6 created in the process will have a dispensing cross section 30 as is schematically shown in FIG. 4b or 6b. The fibre composite strand 6 has the endless fibres 22 and the matrix material 38. These completely fill the passage cross section 36. Since the endless fibres 22 have been previously formed into the unprocessed fibre strand 20 by means of the preforming unit 10, wherein the preforming unit 10 has a passage cross section 34 similar or even identical to the passage cross section 36 of the dispensing unit 18, the advantageous effect is achieved that the distribution of the endless fibres 22 over the dispensing cross section 30 is identical or similar to the distribution of the endless fibres 22 in relation to the unprocessed fibre strand 20. Provision is therefore made for the preforming unit 10 and the dispensing unit 18 to be set such that the formed fibre cross section 26 is at least 70% congruent with the dispensing cross section 30. This offers the advantage that the arrangement of the endless fibres 22 over the formed fibre cross section 26 exhibits only little change in relation to the corresponding distribution of the endless fibres 22 in the dispensing cross section 30.

By means of the application device 2, it can be ensured that a formed fibre composite strand 6 is provided which has an advantageous and/or at least substantially predeterminable distribution of fibres over the associated cross section. If a formed fibre composite strand 6 of said type is used for producing a fibre composite component 58, then the fibre composite component 58 can have geometrically complex shape sections which are simultaneously particularly dimensionally stable and/or capable of bearing load. This is because, based on the advantageous distribution of the fibres 22 in the formed fibre composite strand 6, a corresponding situation can also apply to the fibre composite component 58 to be produced, such that the fibres arranged in a particularly advantageously distributed manner therein ensure the transmission of acting forces in a particularly advantageous manner.

For the application device 2, provision may furthermore be made for the latter to have a curing unit. The curing unit may serve for curing the formed fibre composite strand 6. In one advantageous embodiment, the application device 2 has, for this purpose, a heating unit which constitutes at least a part of the curing unit. The heating unit may also constitute the entire curing unit. The heating unit is designed for warming the formed fibre composite strand 6. Accordingly, the heating unit may for example be assigned to the postforming unit 14. When the formed fibre composite strand 6 exits the application unit 2, then the formed fibre composite strand 6 may have been warmed in advance by means of the heating unit, which then leads to the curing of the formed fibre composite strand 6, in particular during the depositing of the formed fibre composite strand 6. This applies in particular if the incompletely cross-linked matrix material used for producing the fibre composite strand 28 is configured as a thermosetting matrix material.

Alternatively or in addition, the curing unit of the application device 2 may have an exposure unit 40. The exposure unit 40 is designed to divert light with a wavelength spectrum onto the formed fibre composite strand 6, such that the formed fibre composite strand 6 cures. The light spectrum is preferably selected such that the matrix material of the formed fibre composite strand 6 cures. The light is particularly preferably light from the ultraviolet spectrum. Thus, for the exposure unit, use may be made of a UV laser 44 which outputs UV light. This UV light can then be diverted onto the formed fibre composite strand 6. Here, the diverting of the light may be performed by virtue of said light being directed in targeted fashion onto the dispensed formed fibre composite strand 6. This may be realized preferably by means of a diverting mirror 42 of the exposure unit 40. The UV laser 44 for generating the UV light may likewise be assigned to the exposure unit 40. A corresponding laser beam 46 is directed from the UV laser 44 firstly onto a mirror 42 and then onto the formed fibre composite strand 6.

It is basically possible for the exposure unit 40 to be coupled to the application device 2. This is however not necessarily the case. Accordingly, the exposure unit 40 may be arranged in static fashion or may be assigned to the handling device 4. The advantageous embodiments, advantageous features and/or effects discussed above then apply analogously.

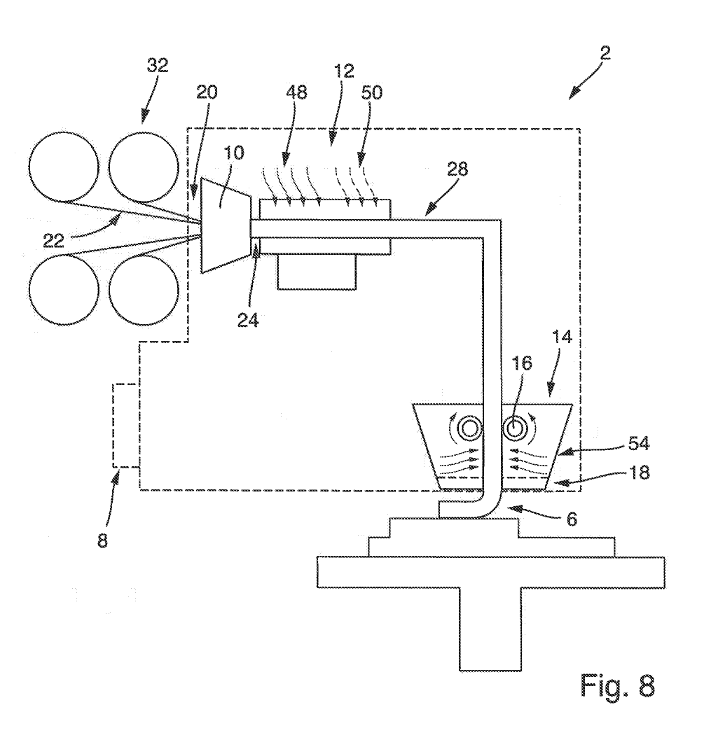

It has been discussed above that, for the impregnation, use may preferably be made of an incompletely cross-linked thermosetting matrix material. The use of a thermosetting matrix material is however not to be regarded as limiting. This is because the incompletely cross-linked matrix material may particularly preferably be configured as a thermoplastic matrix material. FIG. 8 illustrates the above-discussed application device 2, as has been discussed in conjunction with FIG. 1, wherein, however, the impregnating unit 12 is designed for impregnating the fibres with an incompletely cross-linked thermoplastic matrix material. For this purpose, the impregnating unit 12 may have a warming unit 48 and a cooling unit 50. The warming unit 48 may be designed to warm the thermoplastic matrix material such that it is flowable and can thus serve for impregnating the formed fibre strand with the thermoplastic matrix material. When this has taken place, the formed fibre strand impregnated with the thermoplastic matrix material can be cooled, such that the fibre composite strand 28 is then created.

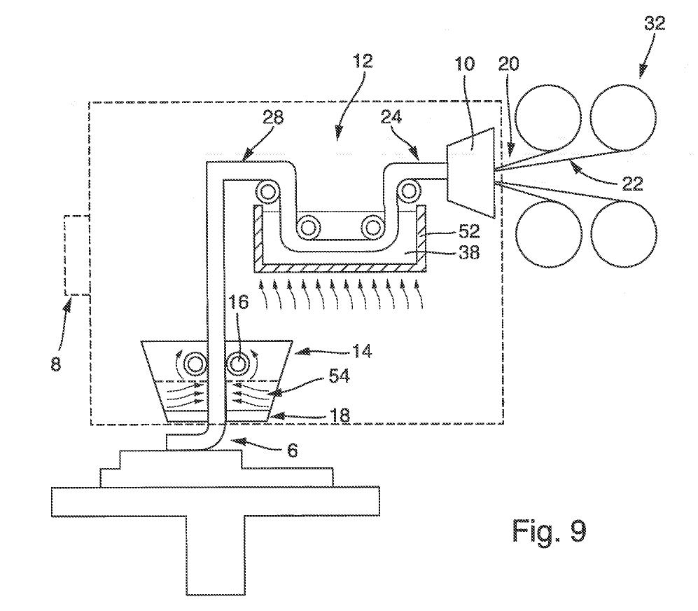

A further design variant of the impregnating unit 12, which is likewise designed for impregnating the formed fibre strand 24 with thermoplastic matrix material, is illustrated schematically in FIG. 9. This involves a trough-like vessel 52 into which thermoplastic matrix material 38 is introduced. Furthermore, the impregnating unit 12 is designed to warm the thermoplastic matrix material 38 in the trough-like vessel 52 such that said material is flowable. As discussed above in conjunction with FIG. 7, the formed fibre strand 24 is guided through the trough-like vessel 52 with the matrix material 38, such that the impregnation takes place here.

A further warming unit 54 may furthermore be provided for the dispensing unit 14. The further warming unit 54 may be formed integrally with the postforming unit 14. The further warming unit 54 is preferably designed to warm the fibre composite strand pressed through the dispensing unit 18, such that said fibre composite strand adopts the desired formed fibre cross section 26, and thus the formed fibre composite strand 6 can be created and dispensed.

Furthermore, the application device 2 may be assigned a further cooling unit for cooling the fibre composite strand 28 passing from the impregnating unit 12. Furthermore, the application device 2 may be assigned a further cooling unit for cooling the formed fibre composite strand 6. The or each cooling unit may be designed as an air blower unit which is designed to direct cooling air onto the formed fibre composite strand 6 or onto the fibre composite strand 28. Other cooling units, which are operated for example with a liquid coolant, such as oil, are however basically also conceivable. Thus, each cooling unit may have a heat exchanger which is connected to a cooling circuit. Thus, one of the cooling units can be designed for cooling the fibre composite strand 28, in particular such that the associated thermoplastic matrix material solidifies. Furthermore, the other cooling unit may be designed for cooling the formed fibre composite strand 6, in particular such that the associated thermoplastic matrix material solidifies.

Reference is finally made once again to FIG. 2, which illustrates an advantageous embodiment of the system 56. The system 56 serves for producing a fibre composite component 58. The system 56 has a handling device 4. The handling device 4 may for example be designed as a robot. Furthermore, the system 56 has an application device 2. Said application device 2 may be designed correspondingly to one of the embodiments discussed above. Reference is therefore preferably made to the explanations above. The application device 2 is fastened by means of its associated coupling unit 8 to a receiving unit 60 of the handling device 4. The receiving unit 60 is preferably designed as an end section on the arm of the handling device 4. If the handling device 4 is designed as a robot arm, the receiving unit 60 may thus be formed on the arm end of the robot arm. The handling device 4 is designed to move the associated receiving unit 60 in space in a controlled manner. Furthermore, the application device 2 is fully supported by the handling device 4. During the operation of the system 56, it is thus possible for a formed fibre composite strand 6 to be dispensed by the application device 2, which formed fibre composite strand then constitutes a section of the fibre composite component 58 to be produced. Since the application device 2 is freely movable in space by means of the handling device 4, multiple sections of the fibre composite component 58 to be produced can be produced in succession by means of the application device 2, such that ultimately the entire fibre composite component 58 is created. The system 56 may be designed, and/or the associated system control unit may be configured, for this purpose. By virtue of the fact that the application device 2 is freely movable in space, it is also possible to produce fibre composite components 58 with a complex geometrical structure.

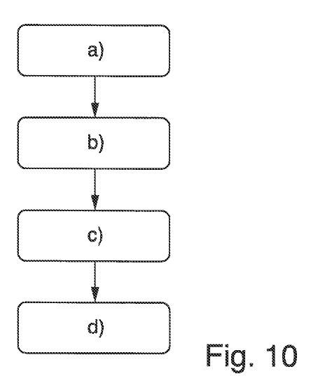

FIG. 10 illustrates an exemplary embodiment of the method for dispensing a fibre composite strand 6 by means of an application device 2, wherein the application device 2 is detachably fastenable by means of an associated coupling unit 8 to a handling device 4, such that the application device 2 is movable in space by the handling device 4.

In a first step a) of the method, provision is made for continuous formation of an unprocessed fibre strand 20, which is fed continuously to a preforming unit 10 of the application device 2 and which has a multiplicity of endless fibres 22, into a formed fibre strand 24 with a formed fibre cross section 26 settable by the preforming unit 10. In a second step b) of the method, provision is made for continuous impregnation of the formed fibre strand 24 with an incompletely cross-linked matrix material 38, by means of an impregnating unit 12 of the application device 2, to realize a fibre composite strand 28, wherein the formed fibre strand 24 is fed continuously to the impregnating unit 12. In a third step c), provision is made for continuous pressing of the fibre composite strand 28, which is fed continuously to a drive unit 14 of the application device 2 from the impregnating unit 12, to and through a dispensing unit 18 of the application device 2 by means of the drive unit 16. In a fourth step d) of the method, provision is made for continuous forming of the fibre composite strand 28, which is pressed continuously through the dispensing unit 18, into a formed fibre composite strand 6 by means of the dispensing unit 18 with a dispensing cross section 30 settable by the dispensing unit 18, and dispensing of same, wherein the preforming unit 10 and the dispensing unit 18 can be set such that the formed fibre cross section 26 is at least 70% congruent with the dispensing cross section 30.

It is additionally pointed out that “having” does not rule out other elements or steps, and “a” or “an” does not rule out a multiplicity. It is furthermore pointed out that features that have been described with reference to one of the above exemplary embodiments may also be used in combination with other features of other exemplary embodiments described above. Reference designations in the claims are not to be regarded as limiting.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. An application device for a handling device and for dispensing a formed fibre composite strand, comprising:
a coupling unit by which the application device is detachably fastenable to the handling device, such that the application device is movable in space by the handling device;
a preforming unit;
an impregnating unit; and
a postforming unit having a drive unit and having an adjustable dispensing unit;
wherein the preforming unit is configured to continuously form an unprocessed fibre strand, having a multiplicity of endless fibres, into a formed fibre strand with a formed fibre cross section settable by the preforming unit;
wherein the impregnating unit is configured to continuously develop the formed fibre strand, into a fibre composite strand by impregnation with an incompletely cross-linked matrix material;
wherein the drive unit of the postforming unit is configured to continuously press the fibre composite strand, to and through the dispensing unit;
wherein the dispensing unit is configured to continuously form the fibre composite strand, into a formed fibre composite strand with a dispensing cross section settable by the dispensing unit, and to dispense same; and
wherein the preforming unit and the dispensing unit are set such that the formed fibre cross section is at least 70% congruent with the dispensing cross section.

2. The application device according to claim 1, wherein the preforming unit has a first tool receptacle and a first forming tool held in an exchangeable manner by the first tool receptacle, and
wherein the formed fibre cross section is determined by the first forming tool.

3. The application device according to claim 1, wherein the dispensing unit has a second tool receptacle and a second forming tool held in an exchangeable manner by the second tool receptacle, and
wherein the dispensing cross section is determined by the second forming tool.

4. The application device according to claim 3, wherein the first forming tool and the second forming tool are determined and/or configured relative to one another such that the formed fibre cross section is at least 70% congruent with the dispensing cross section.

5. The application device according to claim 1, wherein the preforming unit has multiple adjustable preforming tool parts for forming the formed fibre strand, and
wherein the preforming unit is controllable for the adjustment of the preforming tool parts in order to form the formed fibre strand with a formed fibre cross section set in a controlled manner.

6. The application device according to claim 1, wherein the dispensing unit has multiple adjustable dispensing forming tool parts for forming the formed fibre composite strand, and
wherein the dispensing unit is controllable for the adjustment of the dispensing forming tool parts in order to form the formed fibre composite strand with a dispensing cross section set in a controlled manner.

7. The application device according to claim 1, wherein the application device has an applicator control unit configured to control the preforming unit and/or the dispensing unit such that the formed fibre cross section is at least 70% congruent with the dispensing cross section.

8. The application device according to claim 1, wherein the application device has a curing unit for curing the formed fibre composite strand, or has a solidification unit for solidifying the formed fibre composite strand.

9. The application device according to claim 8, wherein the curing unit comprises a warming unit for warming the formed fibre composite strand.

10. A system for dispensing a formed fibre composite strand, comprising:
an application device according to claim 1,
a handling device configured to move an associated receiving unit in space in a controlled manner, and
a system control unit for controlling the handling device;
wherein the coupling unit is fastened to the receiving unit such that the application device is connected to the handling device and is fully supported by the handling device.

11. The system according to claim 10, wherein the applicator control unit is assigned to the system control unit, is controlled by the system control unit and/or is constituted by the system control unit.

12. The system according to claim 10, wherein the system control unit is configured to control the drive unit and/or the dispensing unit by the applicator control unit.

13. The system according to claim 10, wherein the system has an exposure unit configured to direct light onto the formed fibre composite strand such that the formed fibre composite strand cures.

14. A method for dispensing a formed fibre composite strand by an application device which, by an associated coupling unit, is detachably fastenable to a handling device, such that the application device is movable in space by the handling device, wherein the method comprises:
a) continuously forming an unprocessed fibre strand, the unprocessed fibre strand being fed continuously to a preforming unit of the application device and having a multiplicity of endless fibres, into a formed fibre strand with a formed fibre cross section settable by the preforming unit;
b) continuously impregnating the formed fibre strand with an incompletely cross-linked matrix material, by an impregnating unit of the application device, to realize a fibre composite strand, wherein the formed fibre strand is fed continuously to the impregnating unit;
c) continuously pressing the fibre composite strand, is the fibre composite strand being fed continuously to a drive unit of the application device from the impregnating unit, to and through a dispensing unit of the application device by the drive unit; and
d) continuously forming the fibre composite strand, is the fibre composite strand being pressed continuously through the dispensing unit, into a formed fibre composite strand by the dispensing unit with a dispensing cross section settable by the dispensing unit, and dispensing the formed fibre composite strand, wherein the preforming unit and the dispensing unit are set such that the formed fibre cross section is at least 70% congruent with the dispensing cross section.

15. The method according to claim 14, wherein the preforming unit has multiple adjustable preforming tool parts for forming the formed fibre strand, the preforming unit is controllable for the adjustment of the preforming tool in order to form the formed fibre strand with a formed fibre cross section set in a controlled manner, the dispensing unit has multiple adjustable dispensing forming tool for forming the formed fibre composite strand, the dispensing unit is controllable for the adjustment of the dispensing forming tool parts in order to form the formed fibre composite strand with a dispensing cross section set in a controlled manner, and the preforming unit and/or the dispensing unit are/is controlled such that the formed fibre cross section is at least 70% congruent with the dispensing cross section.

16. The method according to claim 14, wherein the application device is fastened by the coupling unit to a receiving unit such that the application device is connected to the handling device and is fully supported by the handling device, and
wherein the application device is, by the handling device, guided through space such that the dispensing unit is guided along a dispensing path while the application device continuously dispenses the formed fibre composite strand, such that the fibres in the formed fibre composite strand extend at least substantially without bends and/or without loops along the dispensing path.
